(19) United States
(12) Patent Application Publication
(10) Pub. No.: US 2011/0305382 A1
(43) Pub. Date: Dec. 15, 2011

(54) IMAGE PROCESSING METHOD AND RADIOGRAPHIC APPARATUS USING THE SAME

(76) Inventor: Wataru Takahashi, Uji-shi (JP)

(21) Appl. No.: 13/151,542

(22) Filed: Jun. 2, 2011

(30) Foreign Application Priority Data
Jun. 10, 2010 (JP) JP2010-133064

(51) Int. Cl. G06K 9/40; G06K 9/00

(52) U.S. Cl. 382/132; 382/275

(57) ABSTRACT

An image processing method with use of band images is provided including a band image generation step for generating the band images through extracting a portion of frequency components in a source image having a subject image falling thereon, a conversion step for converting each of the band images into an absolute value suppression image having a suppressed absolute value of pixel data in reference to input values prior to conversion as well as output values subsequent to the conversion, and an image processing step for performing image processing to the source image based on the absolute value suppression image.

### BACKGROUND OF THE INVENTION

(1) Field of the Invention

This invention relates to a method of processing a radiographic image with a subject falling thereon, and radiographic apparatus using thereof. More particularly, this invention relates to an image-processing method that allows high-frequency enhancement processing and dynamic range compression processing, and radiographic apparatus using the method.

(2) Description of the Related Art

Medical institutions are equipped with radiographic apparatus for acquiring a subject image with radiation. When an image is subjected to given image processing, the image has an emphasized structure of such as a blood vessel that falls thereon, which may result in easier diagnosis. Accordingly, the conventional radiographic apparatus may process an acquired image through image processing. Specifically, examples of the image processing that the radiation photography apparatus may adopt include high-frequency enhancement processing and dynamic range compression processing. See Japanese Patent Publications No. H10-075395, H10-171983, H06-301766, and H09163227.

In order to perform the above two image processing, two or more band images need to be generated from a radiographic image having a subject image falling thereon (hereinafter, appropriately referred to as a source image.) Here, the band image is an image formed of only frequency components in a certain band in the source image, and the band image has a given frequency component extracted from the source image. Two or more band images are generated based on the source image. They differ from one another in band with the frequency components extracted from the source image. Consequently, one band image contains only high-frequency components in the source image, whereas another band image contains only low-frequency components in the source image. The band images are sequentially generated from a high-frequency component side through image processing to the source image. Here, the high-frequency component in the source image is a component with a detailed structure in a projected image of the subject falling thereon. The low-frequency component in the source image is a component with a rough structure in the projected image of the subject falling thereon.

Now, description will be given of the conventional image processing. For performance of high-frequency enhancement processing or dynamic range compression processing in accordance with the conventional image processing, band images α, β, γ, δ are generated from a source image P0 having a subject image falling thereon, which is illustrated in FIG. 16. The band images α, β, γ, δ are converted into absolute value suppression images LUT(α), LUT(β), LUT(γ), LUT(δ), respectively. Subsequently, the absolute value suppression images generated as above are added up to one another for generating a sum image ΣLUT. The image ΣLUT is used in a subsequent image processing step.

The band images α, β, γ, δ are converted into the absolute value suppression images LUT(α), LUT(β), LUT(γ), LUT(δ), respectively, with use of a translation table. Description will be given of the translation table T. FIG. 17 is a graph associated with input values and output values of the translation table T. Here, the input value illustrates a value prior to conversion, and the output value illustrates a value subsequent to the conversion. The graph is a nonlinear profile symmetric about an origin point. More specifically, where the input value falls within a range of “+a”, a relationship between the input and output values corresponds to a given function “f”. Where the input value falls from “a” to “b” or from “−b” to “−a”, a relationship between the input and output values is in a proportional relationship. Where the input value lies over “b” or less than “−b”, a relationship between the input and output values corresponds to a given function “g”.

The generation processing of the absolute value suppression image LUT may suppress irregularities of the image appearing in the processed image finally acquired in the image processing. For instance, suppose that the band images α, β, γ, δ are used as they are with no absolute value suppression image LUT being generated. Then, when the image generated from the band images α, β, γ, δ and the source image P0 are superimposed for generation of the processed image, a high positive or negative value of the band images α, β, γ, δ is directly superimposed on the source image P0, which leads to decreased visibility of the processed image.

Such phenomenon may occur as follows. That is, where the image of the subject having a metal piece embedded therein falls on the source image P0, a false image may readily appear in a boundary between the metal piece and the tissue of the subject in the processed image. In the source image P0, the metal piece extremely differs from the tissue of the subject in pixel data. In the band images α, β, γ, δ, the extreme difference should be indicated as the frequency component. Specifically, an extremely large positive value or an extremely small negative value (i.e., a value with a large absolute value of the pixel data) is assigned to express the boundary. This may appear as a false image that borders the boundary upon generation of the processed image. Accordingly, a large absolute value of the pixel data that appears in the band images α, β, γ, δ is converted into a small absolute value, whereby an absolute value suppression image LUT is generated.

Moreover, an absolute value of appropriately “0” that the band images α, β, γ, δ have is superimposed on the source image P0 as it is. Consequently, there arise a problem that visibility of the processed image decreases. Where the subject image having many noise components falls on the source image P0, the noise components are emphasized through the image processing, which readily causes occurrence of a false image in the processed image. The noise components causing the false image should be contained in the band images α, β, γ, δ. Specifically, the noise components are contained in the band images α, β, γ, δ as a minimum absolute value of pixel data. This may appear as a false image that emphasizes the noise components in generation of the processed image. Accordingly, the pixel data value of approximately “0” appearing in the band images α, β, γ, δ is once converted into a small pixel data value, and then an absolute value suppression image LUT is generated.

However, the foregoing image processing method has following drawbacks.

That is, the conventional method has the problem that an operator cannot simply control image processing. For control of the image processing by the operator, the translation table T needs to vary that is used for generation of the absolute value suppression image LUT. It is complicated for the operator to manually change each one of the values of the translation table T. That is because the translation table T is specified with the functions “f”, “g”. Now the configuration is considered that the operator can change the functions “f”, “g” specifying a relationship between the input and output values of the translation table T. The functions “f”, “g” are each a nonlinear function. In addition, the function has a restriction mentioned later. Consequently, it s quite difficult for the operator to change the functions “f”, “g” satisfactorily. Moreover, two functions “f”, “g” must be controlled, and thus the operator is forced to control complicated and unclear parameters.

One reason for inflexibility in performing the above image processing is a restriction that a graph indicating a relationship between the input and output values shown in FIG. 17 should be smooth. In the graph shown in FIG. 17, the function specifying the relationship between the input and output values differs at four input points of “±a ” and “±b”. Such restriction as below is provided because the graph without having a continuous and smooth profile at the points causes artifacts in the processed image.

The reason for the above will be described. Suppose for example, that the graph is not continuous or smooth at the point where the input value is “p0”. In the graph indicating the relationship between the input and output values, “a” lies on a boundary between the first and second functions. For instance, an input value p1 slightly less than the value p0 is converted into an output value q1 obtained with the first function. Moreover, an input value p2 slightly larger than the value p0 is converted into an output value q2 obtained with the second function. Moreover, the value p1 in the band image α, β, γ, δ is converted into the value q1 in the absolute value suppression image LUT. The value p2 in the band image α, β, γ, δ is converted into the value q2 in the absolute value suppression image LUT.

Here, the first function and the second function are not continuous or smooth. Thus, the input values q1 quite differ from the output value q2. Accordingly, although the value p1 and the value p2 in the band image α, β, γ, δ are close to each other, they are converted to the value q1 and q2, respectively, that quite differs from each other in the absolute value suppression image LUT. This influence may cause disturbance of the processed image to be finally acquired and decreased visibility of the processed image.

Such configuration avoids free determination of the relationship between the input and output values that specifies the translation table T. Accordingly, the operator has a difficulty in control of the translation table T.

### SUMMARY OF THE INVENTION

This invention has been made regarding the state of the art noted above, and its object is to provide an image processing method and radiographic apparatus using the method that allows easy control by an operator.

This invention is constituted as stated below to achieve the above object. That is, an image processing method according to this invention includes a band image generation step for generating band images through extracting a portion of frequency components in a source image having a subject image falling thereon; a conversion step for converting each of the band images into an absolute value suppression image having a suppressed absolute value of pixel data in reference to input values prior to conversion as well as output values subsequent to the conversion; and an image processing step for performing image processing to the source image based on the absolute value suppression image. In the conversion step, the translation table to be referred to has an output value of “0” where the absolute value of the input value is less than or equal to a threshold. The translation table to be referred to has an output value increasing in accordance with increase of an input value where the input value is positive and larger than the threshold. The translation table to be referred to has an output value decreasing in accordance with decrease of an input value where the input value is negative and smaller than the opposite of the threshold.

Moreover, radiographic apparatus according to this invention includes a radiation source for emitting radiation; a radiation detecting device for detecting radiation; a source image generation device for generating a source image, that has a subject image falling thereon, based on detection signals outputted from the radiation detecting device; a band image generation device for generating band images through extracting a portion of frequency components in the source image; a conversion device for converting each of the band images into an absolute value suppression image having a suppression absolute value of pixel data in reference to input values prior to conversion as well as output values subsequent to the conversion; and an image processing device for performing image processing to the source image based on the absolute value suppression image. In the conversion step, the translation table to be referred to has an output value of “0” where the absolute value of the input value is less than or equal to a threshold. The translation table to be referred to has an output value increasing in accordance with increase of an input value where the input value is positive and larger than the threshold. The translation table to be referred to has an output value decreasing in accordance with decrease of an input value where the input value is negative and smaller than the opposite of the threshold.

According to the above configuration, the absolute value suppression image is generated in accordance with the translation table. The translation table has an output value of “0” where the absolute value of the input value is less than or equal to a threshold. Where the absolute value of the input value is larger than the threshold, the relationship between the input and output values may be indicated as a conventional smooth curve. According to the conventional configuration, the relationship between the input and output values is indicated as the smooth curve relative to every input value. Otherwise, it has been considered that artifacts appear in the image to be generated from the absolute value suppression image. In contrast to this, no visible artifact appears where a discontinuous portion in the graph indicating the relationship between the input and output values has a threshold (and the opposite of the threshold) sufficiently close to “0”. Such configuration may realize easy formation of the translation table even when the relationship is not determined with a complicated function as in the conventional art.

Moreover, it is more desirable that the foregoing image processing method further includes a threshold changing step for receiving an input instruction to vary the threshold having an upper limit of a given value.

Moreover, it is more desirable that the foregoing radiographic apparatus further includes a threshold changing device for receiving an input instruction to vary the threshold having an upper limit of a given value.

According to the foregoing configuration, the threshold may vary. As the threshold increases, pixel data having a value of “0” increases that forms the absolute value suppression image. Consequently, the state of image processing to the source image is changed. In so doing, the operator may control the extent of image processing to the source image by merely control of the threshold of a single value.

Moreover, in the foregoing image processing method, it is more desirable that the threshold used for conversion of the band images in the conversion step differs in accordance with a site to be imaged or types of operations.

Moreover, in the foregoing radiographic apparatus, it is more desirable that the threshold that the conversion device adopts for conversion of the band images differs in accordance with a site to be imaged or types of operations.

The foregoing configuration is one example of specific configurations of this invention. The state where the subject image falls on the source image differs in accordance with the site to be imaged or types of operations. Accordingly, variation of the threshold in accordance with the site to be imaged or types of operations may realize proper image processing to the subject image falling on the source image.

Moreover, in the foregoing image processing method, it is more desirable that the threshold used for conversion of the band images in the conversion step differs in each band image.

Moreover, in the foregoing radiographic apparatus, it is more desirable that the threshold that the conversion device adopts for conversion of the band images differs in each band image.

The foregoing configuration is one example of specific configurations of this invention. The threshold differs in each band image. In this way, image processing may be controlled with higher flexibility. In addition, the operator only controls limited types of parameters for operations. Consequently, excellent ease of operation may be achieved.

Moreover, in the foregoing image processing method, it is more desirable that the threshold used for conversion of the band images in the conversion step differs in accordance with an amount of exposure in taking the source image.

Moreover, in the foregoing radiographic apparatus, it is more desirable that the threshold that the conversion device adopts for conversion of the band images differs in accordance with an amount of exposure in taking the source image.

The foregoing configuration is one example of specific configurations of this invention. The threshold differs in accordance with an amount of exposure in taking the source image. In this way, image processing may be controlled with higher flexibility.

Moreover, in the foregoing image processing method, it is more desirable that high-frequency enhancement processing for enhancement of the high-frequency components to the source image or dynamic range compression processing for controlling distribution of the pixel data in the source image is performed in the image processing step.

Moreover, in the foregoing image processing apparatus, it is more desirable that the image processing device performs high-frequency enhancement processing for enhancement of the high-frequency components to the source image or dynamic range compression processing for controlling distribution of the pixel data in the source image.

The foregoing configuration is one example of specific configurations of this invention. That is, this invention adopts two types of image processing, i.e., high-frequency enhancement processing for enhancement of the high-frequency components and dynamic range compression processing for controlling distribution of the pixel data in the source image. In either of the image processing, the absolute value suppression image is used. Therefore, this invention is applicable to the image processing.

Moreover, in the foregoing image processing method, it is more desirable that the threshold used for conversion of the band images in the conversion step differs in accordance with types of image processing.

Moreover, in the foregoing radiographic apparatus, it is more desirable that the threshold that the conversion device adopts for conversion of the band images differs in accordance with types of image processing.

The foregoing configuration is one example of specific configurations of this invention. Variation in threshold in accordance with types of image processing may realize control of the image processing with high flexibility.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a functional block diagram illustrating a configuration of X-ray apparatus according to Embodiment 1.

FIG. 2 is a schematic view illustrating frequency distribution of a source image according to Embodiment 1.

FIGS. 3 to 5 are schematic views each illustrating frequency distribution of a band image according to Embodiment 1.

FIG. 6 is a flow chart illustrating operation of the X-ray apparatus according to Embodiment 1.

FIGS. 7 to 15 are schematic views each illustrating operation of the X-ray apparatus according to Embodiment 1;

FIGS. 16 and 17 are schematic views each illustrating conventional X-ray apparatus.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

An embodiment of this invention will be described hereinafter. X-rays in the embodiment correspond to the radiation in this invention. An FPD is the abbreviation of a flat panel detector.

### Whole Configuration of X-ray Apparatus

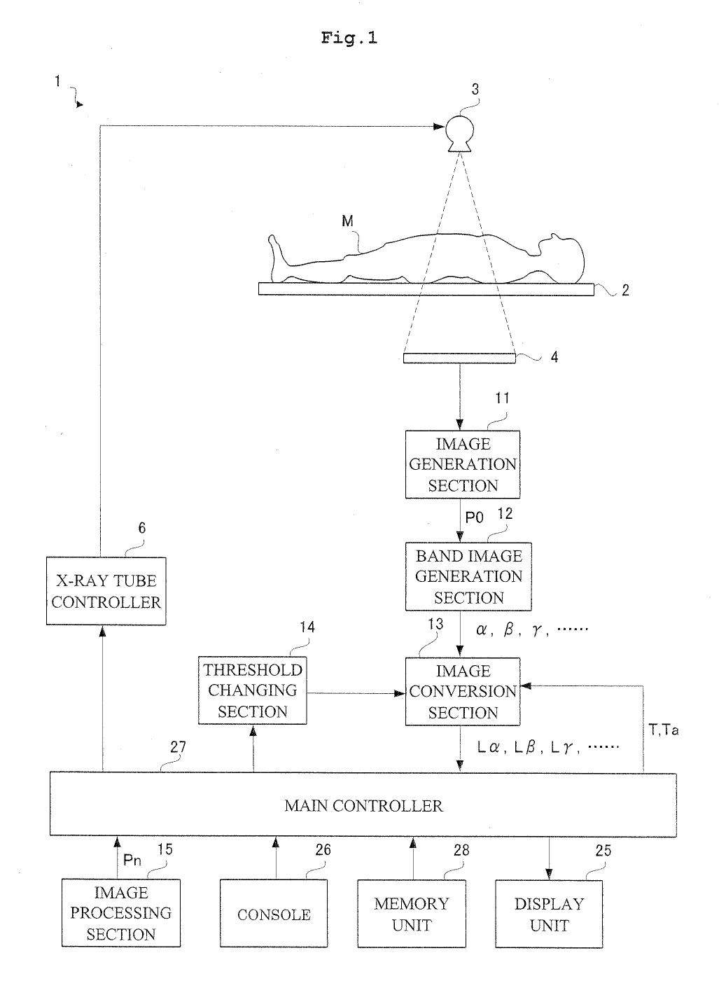

Firstly, description will be given of a configuration of X-ray apparatus 1 according to Embodiment 1. As shown in FIG. 1, the X-ray apparatus 1 includes a top board 2 for supporting a subject M, an X-ray tube 3 above the top board 2 for emitting X-rays, and an FPD 4 below the top board 2 for detecting X-rays. The X-ray tube 3 corresponds to the radiation source in this invention. The FPD 4 corresponds to the radiation-detecting device in this invention.

An X-ray tube controller 6 is provided for controlling the X-ray tube 3 with a given tube current, a tube voltage, and a pulse width. The FPD 4 detects X-rays emitted from the X-ray tube 3 and transmitting through the subject M, and generates a detection signal. The detection signal is sent out to an image generation section 11, where a source image P0 is generated having a projected image of the subject M falling thereon. A display unit 25 is provided for displaying the projected image of the subject M outputted from the image generation section 11. The image generation section 11 corresponds to the image generation device in this invention.

The X-ray apparatus 1 according to Embodiment 1 further includes a band image generation section 12, an image conversion section 13, a threshold changing section 14, and an image processing section 15. The band image generation section 12 generates band images α, β, γ, . . . having frequency components in each band that are extracted from the source image P0. The image conversion section 13 converts pixel data of the band images α, β, γ, . . . into data of a lower absolute value to generate an absolute value suppression image (LUT image Lα, Lβ, Lγ, . . . ). The threshold changing section 14 changes a threshold referred in operation of the image conversion section 13. The image processing section 15 performs image processing to the source image P0 using the LUT images Lα, Lβ, Lγ, . . . to generate a processed image Pn. The band image generation section 12 corresponds to the band image generation device in this invention, and the image conversion section 13 to the image conversion device in this invention. The threshold changing section 14 corresponds to the threshold changing device in this invention, and the image processing section 15 to the image processor in this invention.

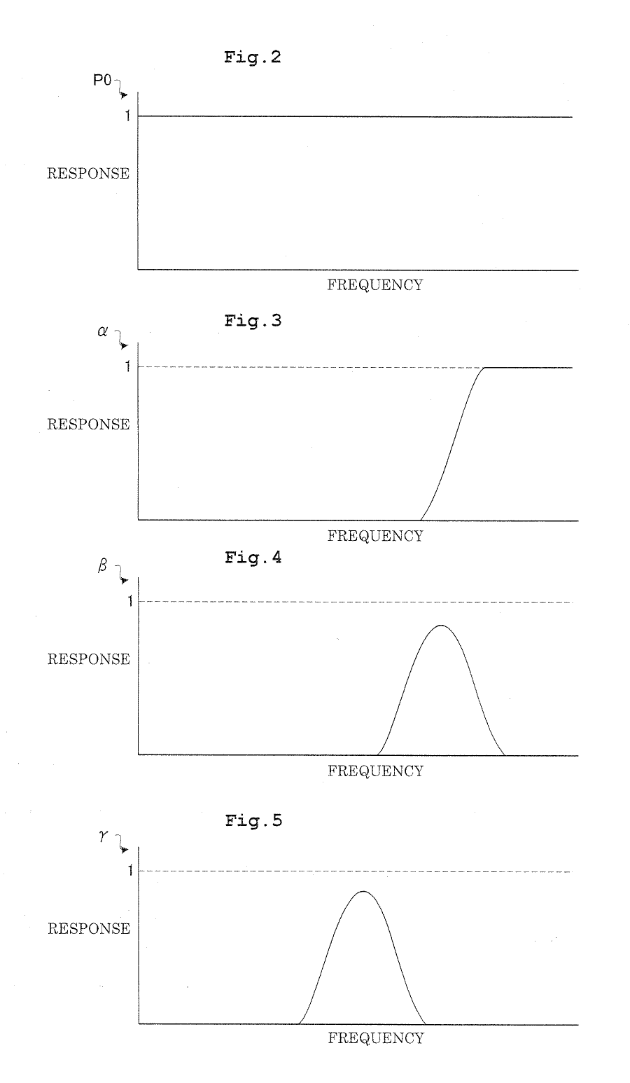

Next, description will be given of the band images α, β, and γ. FIG. 2 is the result of conducting frequency analysis of the source image P0. The source image P0 has wide frequency components from high frequencies to low frequencies. Here, for expediency of explanation, it is assumed that every frequency has a response of “1”. FIG. 3 is the result of conducting frequency analysis of the first band image a. As illustrated in FIG. 3, the first band image a is an image having the extracted frequency component that is in a highest frequency region in the source image P0. FIG. 4 is the result of conducting frequency analysis of the second band image β. As illustrated in FIG. 4, the second band image β is an image having the extracted frequency component that is in a secondary highest frequency region in the source image P0. FIG. 5 is the result of conducting frequency analysis of the third band image γ. As illustrated in FIG. 5, the third band image γ is an image having the extracted frequency component that is in a thirdly highest frequency region in the source image P0. As above, the band images α, β, γ have the frequency components higher in this order that are derived from the source image P0.

A console 26 is provided for inputting operator's instructions such as start of emitting X-rays. Moreover, a main controller 27 is provided for performing an overall control of each controller. The main controller 27 has a CPU, and realizes the X-ray tube controller 6 and each section 11, 12, 13, 14, 15 by executing various programs. The above components may be divided into arithmetic units that perform their functions. A memory unit 28 memorizes all parameters with respect to control of the X-ray apparatus 1 such as a parameter used for image processing, an intermediate image generated in connection with the image processing, and a table.

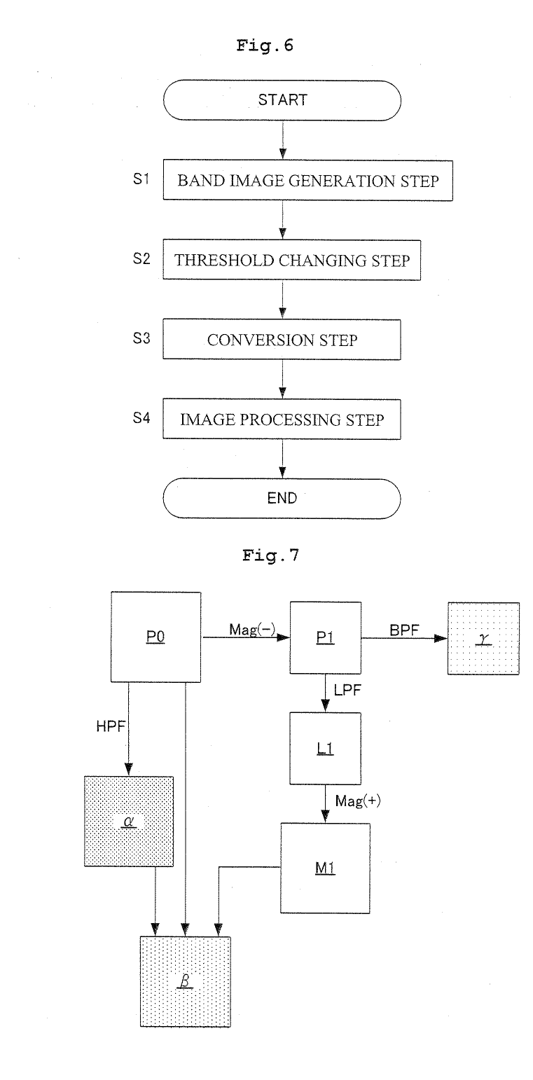

The band image generation section 12, the image conversion section 13, the threshold changing section 14, and the image processing section 15 perform a series of operations, thereby performing image processing such as high-frequency enhancement processing and dynamic range compression processing to the source image P0. Specifically, as illustrated in FIG. 6, the band images α, β, γ are firstly generated (a band image generation step S1), and then the threshold thereof are changed (a threshold changing step S2.) Subsequently, the band image α, β, γ is converted into the LUT image Lα, Lβ, Lγ, respectively (a conversion step S3.) Various image processing is performed with the LUT image Lα, Lβ, Lγ (an image processing step S4.) Description will be given in turn of detailed operation in each step.

### Band Image Generation Step S1

Description will be given of operations of the band image generation section 12. As illustrated in FIG. 7, the band image generation section 12 acquires a first band image α, a second band image β, and a third band image γ in this order. Each of these operations will be described in order.

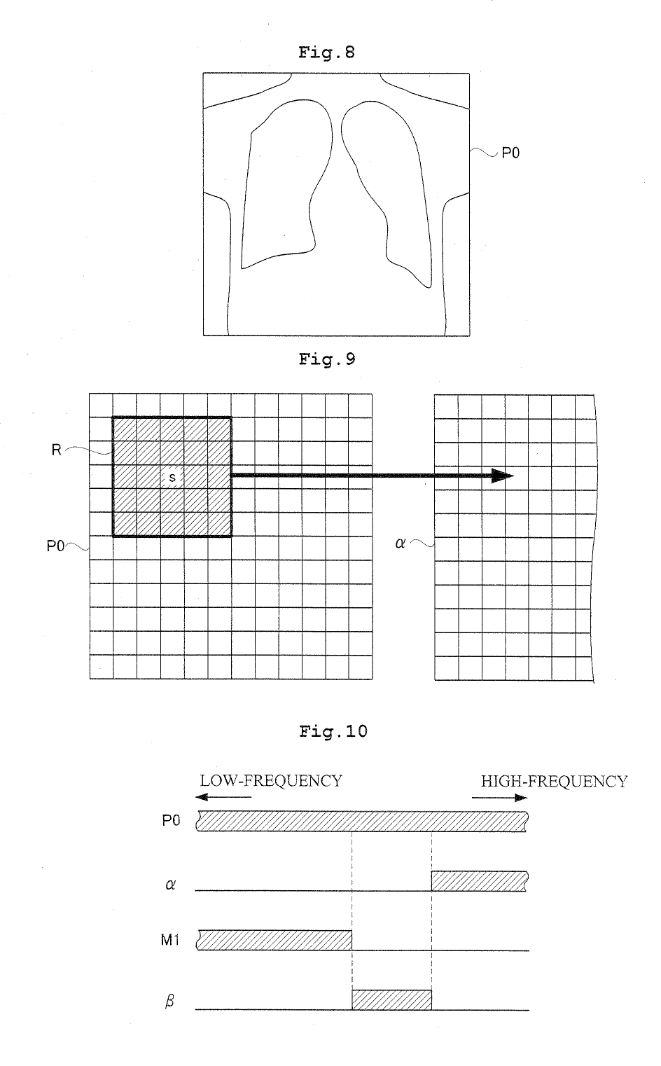

Firstly, description will be given of acquiring the first band image α. The source image P0 generated in the image generation section 11 (see FIG. 8) is sent to the band image generation section 12. The band image generation section 12 applies a matrix serving as a high-pass filter with respect to each of the pixels that form the source image P0. FIG. 9 illustrates a state where a pixel s forming the source image P0 is subjected to high-pass filter processing. The band image generation section 12 reads a matrix of 5 by 5, for example, for the high-pass filters from the memory unit 28, and applies the matrix to the pixel s. Accordingly, as illustrated in FIG. 9, the matrix is applied to a pixel region R of five rows and five columns having the pixel s as a center thereof. Thereafter, the band image generation section 12 applies pixel data obtained through application of the matrix to a position corresponding to the pixel s in the first band image α. The band image generation section 12 performs the same operation as above to all pixels, other than the pixel s, that form the source image P0. The acquired pixel data is brought into correspondence with the source image P0, and is mapped in the first band image α on each occasion. The high-pass filter transmits only the high-frequency components contained in the region R. Consequently, the first band image a becomes a rough image having the pixel data thereof varying finely. The high-pass filter processing is designated by the symbol HPF in FIG. 7.

Next, description will be given of acquiring the second band image β. As illustrated in FIG. 7, the band image generation section 12 generates a reduction image P1 by reducing the source image P0 by half vertically and horizontally. In FIG. 7, the process for reducing an image is designated by the symbol Mag (−).

The band image generation section 12 performs low-pass filter processing to the reduction image P1. That is, the band image generation section 12 reads the matrix for the low-pass filter of 5 by 5 from the memory unit 28 having the same dimension as the matrix for the high-pass filters, and applies the matrix to each of the pixels forming the reduction image P1. The pixel data obtained through application of the matrix is brought into correspondence with the reduction image P1 and is mapped in the low-pass image L1, which situation is similar to the explanation using FIG. 9. Differences therebetween are the matrix to be used and the reduced size of the image. As noted above, frequency components may be extracted through reducing once the source image P0 and applying the low-pass filter even when the matrix specifying the band-pass filter does not increase in dimension. Consequently, a calculation cost may significantly be suppressed. The low-pass filter processing is designated by the symbol LPF in FIG. 7.

As illustrated in FIG. 7, the band image generation section 12 generates a magnified image M1 by magnifying the low-pass image L1 twice vertically and horizontally. In FIG. 7, the process for magnifying an image is designated by the symbol Mag (+). That is, the magnified low-pass image M1 has the same size as the source image P0. The band image generation section 12 generates the second band image through subtraction of the first band image a and the magnified low-pass image M1 from the source image P0.

Description will be given of the second band image β. FIG. 10 is a schematic view illustrating a range of the frequency components contained in each image. As shown in FIG. 10, the source image P0 entirely has the frequency components. The first band image α contains only the highest frequency components, and thus has no low-frequency component. On the other hand, the magnified low-pass image M1 is formed only of the low-frequency components in the reduction image P1, and thus has no high-frequency component. As illustrated in FIG. 10, the second band image β has a portion of frequency components among all frequency components of the source image P0 in a section between the lowest-frequency of the first band image a and the highest-frequency of the magnified low-pass image M1.

Description will be next given of the third band image γ. The band image generation section 12 reads the matrix for the band-pass filter of 9 by 9 from the memory unit 28 that is approximately twice the matrix for the low-pass filter, and applies the matrix to each of the pixels forming the reduction image P1. The pixel data obtained through application of the matrix is brought into correspondence with the reduction image P1, and is mapped in the third band image β, which situation is similar to the explanation using FIG. 9. Differences therebetween are various types of matrix to be used, the matrix having appropriately twice the length and width, and the reduction image P1 to be processed having ¼ times the area of the source image P0. In FIG. 7, the band-pass filter processing is designated by the symbol BPF. The third band image γ generated as above additionally has extracted frequency components of the source image P0 in the lower frequency band than the second band image β.

The band image generation section 12 also generates a reduction image P2, other than the reduction image P1, that is obtained through reduction of the reduction image P1 by half vertically and horizontally. The reduction image P2 is also subjected to the band-pass filter processing, whereby a fourth band image δ is generated. The fourth band image δ generated as above additionally has extracted frequency components of the source image P0 in the lower frequency band than the third band image γ. In this way, the band image generation section 12 may generate the band image of the lower frequencies than the third band image γ. The band images may also be used in the subsequent image processing. However, image processing is to be performed with the band images α, β, γ for simple explanation of Embodiment 1.

The image conversion section 13 also has the band images α, β, γ, . . . already sent thereto. Thereafter, the image conversion section 13 converts pixel data forming the band images α, β, δ for generating a respective absolute value suppression image (LUT image Lα, Lβ, Lγ.)

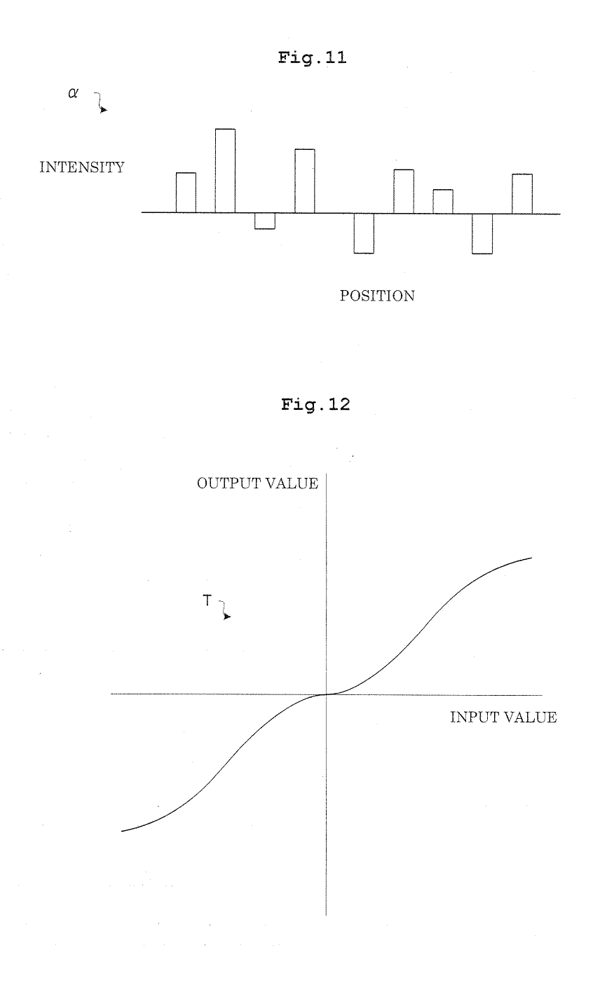

Description will be given in detail of generation of the LUT images Lα, Lβ, Lγ. Description has already been given of the band images α, β, γ having the pixel data mapping therein. The pixel data may be in a range from a positive value to a negative value. FIG. 11 illustrates a specific configuration of the first band image α. The pixel data forming the first band image a has a positive or negative value (intensity) depending on its position.

### Threshold Changing Step S2, Conversion Step S3

The image conversion section 13 reads a translation table T memorized in a memory unit 28, and converts the band images α, β, γ into the absolute value suppression images Lα, Lβ, Lγ, respectively. This processing may suppress irregularities of the image appearing in the processed image Pn to be finally acquired that has already been subjected to image processing. For instance, suppose that the band images α, β, γ are used as they are without generation of the LUT images Lα, Lβ, Lγ. Then, when the images generated from the band images α, β, γ and the source image P0 are superimposed for generation of the processed image Pn, a high positive or negative value of the band images α, β, γ is directly superimposed on the source image P0, which leads to decreased visibility of the processed image Pn. Such phenomenon may occur as follows. That is, where the subject M having a metal piece embedded therein falls on the source image P0, a false image may readily appear in a boundary between the metal piece and the tissue of the subject M in the processed image Pn. In the source image P0, the metal piece extremely differs from the tissue of the subject M in pixel data. In the band images α, β, γ, the extreme difference should be indicated as the frequency component. Specifically, an extremely large positive value or an extremely small negative value (i.e., a value with a large absolute value of the pixel data) is assigned to express the boundary. This may appear as a false image that borders the boundary upon generation of the processed image Pn.

Accordingly, the image conversion section 13 converts a high absolute value of the pixel data that appears in the band images α, β, γ into a lower absolute value for high-frequency enhancement processing, whereby the LUT images Lα, Lβ, Lγ are generated. Moreover, the image conversion section 13 converts a low absolute value of the pixel data that appears in the band images α, β, γ into a further lower absolute value for dynamic range compression processing, whereby the LUT images Lα, Lβ, Lγ are generated. As above, the image conversion section 13 generates the LUT images Lα, Lβ, Lγ that differ from one another depending on types of image processing.

Description will be given of the translation table T that the image conversion section 13 adopts for the above conversion. FIG. 12 is a graph associated with input values and output values of the translation table T. The graph is a nonlinear profile symmetric about an origin point. The image conversion section 13 reads the pixel data forming the band images α, β, γ, and sets it as an input value. Then, the image processor 18 acquires an output value at this time from the translation table T. The image conversion section 13 performs acquisition of the output value to every pixel data forming the first band image α, and maps the output values two-dimensionally, thereby acquiring a first LUT image Lα. Accordingly, every LUT image Lα has an extremely high positive value and an extremely low negative value (i.e. a value with an extremely low absolute value) removed therefrom upon performance of high-frequency enhancement processing or dynamic range compression processing. The image conversion section 13 performs similar processing to the second band image β to generate a second LUT image Lβ. Likewise, the image processor 18 performs similar processing to the third band image γ to generate a third LUT image Lγ. This situation is illustrated on the left side of FIG. 14.

Description will be next given of a threshold “a” as the most characteristic feature in this invention that the image conversion section 13 refers to. In the high-frequency enhancement processing, setting of the threshold “a” may realize control of influences on noise components in the processed image Pn contained in the LUT images Lα, Lβ, Lγ. Moreover, in the dynamic range compression processing, setting of the threshold “a” may realize control of minute influences on noise components in the processed image Pn contained in the LUT images Lα, Lβ, Lγ. FIG. 12 shows a translation table T where the threshold has a value of “0”. In the subsequent high-frequency enhancement processing or dynamic range compression processing, the LUT images Lα, Lβ, Lγ are superimposed on the source image P0 to appear in the processed image Pn. Where the threshold has a value of “0”, the translation table T always has an input value of “0” when an output value is “0”. Accordingly, almost every pixel data that forms the LUT images Lα, Lβ, Lγ does not have a value of “0”. Consequently, the processed image Pn indicates a large influence on the noise components contained in the LUT images Lα, Lβ, Lγ in the high-frequency enhancement processing. Moreover, in the dynamic range compression processing, in addition to indication of the large influence on the noise components, the processed image Pn has minute high-frequency components excessively suppressed.

More excellent visibility may sometimes be achieved when the LUT images Lα, Lβ, Lγ are not superimposed on the source image P0. Such phenomenon, however, is limited in the case where the pixel data forming the source image P0 is around “0”. If image processing is performed with no used of the LUT images Lα, Lβ, Lγ, the pixel data having a large absolute value containing in the band images Lα, Lβ, Lγ is superimposed on the source image P0 as it is. Consequently, this surely leads to decreased visibility of the processed image Pn. According to Embodiment 1, a method of converting pixels differs between the larger and smaller absolute values than the threshold “a” of the pixel data forming the band images α, Lβ, Lγ.

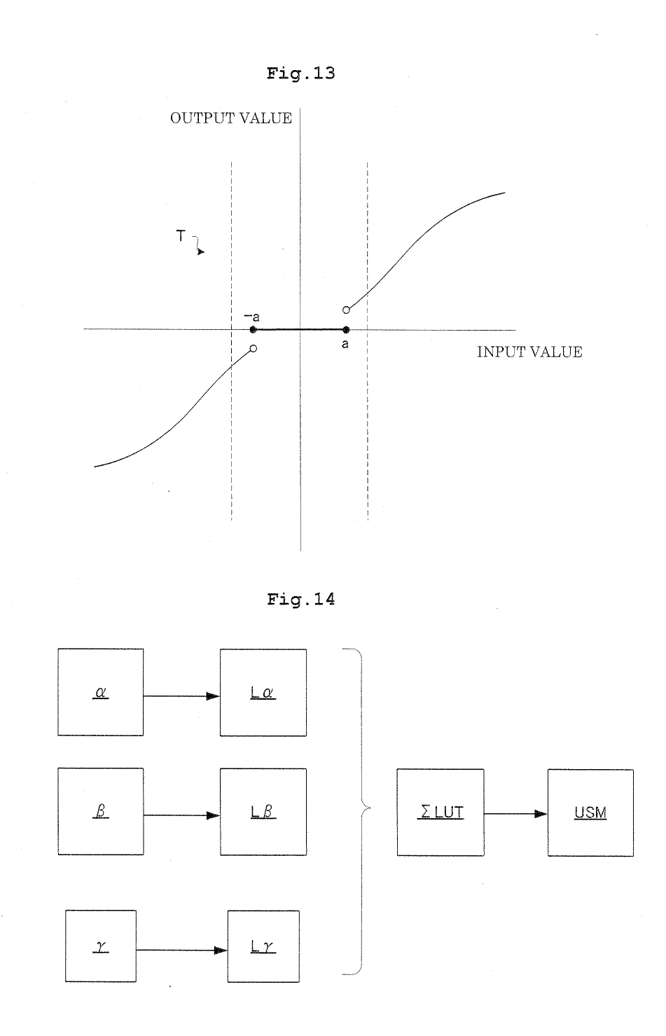

The operator instructs changing of the threshold via a console 26, and the value changing section 14 receives input instructions to change the threshold for changing the threshold “0” into the threshold “a” as instructed. Accordingly, the threshold changing section 14 changes the translation table T as in FIG. 13 from FIG. 12. Let a translation table after conversion be Ta. Description will be given in detail of generation of the LUT images Lα, Lβ, Lγ based on the translation table Ta. The translation table Ta has an output value of “0” when the input value thereof falls from “−a” to “a”. Where the input value lies less than “−a” or over “a”, the output value is determined by a graph, similar to that in FIG. 12, having a nonlinear profile symmetric about an origin point. The LUT images Lα, Lβ, Lγ are to be generated as under with use of the translation table Ta. Specifically, where the pixel data contained in the band images α, β, γ falls from “−a” to “a”, the output value is converted into “0” to be mapped in the LUT images Lα, Lβ, Lγ. Where the pixel data contained in the band images Lα, Lβ, Lγ lies less than “−a” or over “a”, the input value is converted so as to be a small absolute value.

The translation table Ta has an output value of “o” where an absolute value of the input value is equal or less than the threshold. The translation table Ta has an output value increasing in accordance with increase of an input value where the input value is positive and larger than the threshold “a”. Here, increase in the output value is gradually reduced as the input value increases. The translation table Ta has an output value decreasing in accordance with decrease of an input value where the input value is negative and smaller than the opposite “−a” of the threshold “a”. Here, decrease in the output value is gradually reduced as the input value decreases.

Description will be given of the sense of converting the pixel data into “0” that has a small absolute value contained in the band images α, β, γ. As mentioned later, image processing such as high-frequency enhancement processing and dynamic range compression processing is performed through superimposed of the LUT images Lα, Lβ, Lγ (collectively referred to as an LUT image L) on the source image P0. The source image P0 is subjected to image processing under no influence of the LUT image L at a portion where the LUT image L has a pixel data value of “0”. The portion where the LUT image L has a pixel data value of “0” corresponds to a portion where an absolute value of the pixel data contained in the band images α, β, γ is small. That is, the portion of the source image P0 has many superimposed noise components falling thereon in performance of high-frequency enhancement processing. Accordingly, a clearer image with no enhanced noise component may sometimes be acquired without performing image processing to this portion. Moreover, the portion of the source image P0 has only fine high-frequency components falling thereon in performance of dynamic range compression processing to this portion. Accordingly, no overshoot occurs, and thus a clearer image having stored fine high-frequency components may sometimes be acquired without performing image processing. On the other hand, the band images α, β, γ contain pixel data of a large absolute value that is equal or more than the threshold. Consequently, the pixel data is surely converted into pixel data of a small absolute value that is not “0”. Accordingly, no false image appears that borders a boundary between the metal piece embedded in the subject and the tissue of the subject that falls on the processed image Pn to be finally generated.

Description will be given of discontinuousness around the threshold in the graph indicating a relationship between the input and output values expressing the translation table Ta (see FIG. 13.) For instance, the graph of FIG. 13 is discontinuous at two points of “−a” and “a” where the input value is determined with the threshold. Discontinuousness in the graph specifying the translation table causes a step that does not continue to the pixel data forming the processed image Pn, whereby artifacts in the processed image Pn are generated. This is a common knowledge for those of ordinary skill in the art to which this invention pertains. However, no artifact is visible when the processed image Pn is generated actually with the translation table Ta. That is, the operator cannot recognize a step with “a” of a sufficient small value.

The operator may change the threshold “a” via the console 26. When the operator increases the threshold “a”, the value “a” in FIG. 13 increases. Accordingly, influence of the LUT images Lα, Lβ, Lγ is gradually reduced in the image processing such as high-frequency enhancement processing and dynamic range compression processing. On the other hand, when the operator extremely increases the value “a” a sharp change of the pixel value is visible in accordance with the step in the discontinuous part of the graph, which leads to decreased visibility of the processed image Pn.

According to Embodiment 1, an upper limit of the threshold “a” is provided.

Consequently, the operator cannot make the value “a” larger than that in a positive region of the input values from the dotted line in FIG. 13. Likewise, the operator cannot make the value “−a” smaller than that in a negative region of the input values from the dotted line in FIG. 13.

Description will be given of a relationship between changing of the threshold “a” and the processed image Pn. In high-frequency enhancement processing, as the threshold “a” decreases, more high-frequency components and noise components of smaller signals are stored in the LUT images Lα, Lβ, Lγ. Consequently, the processed image Pn has enhanced fine high-frequency components and noise components in comparison with the source image P0. In contrast to this, as the threshold “a” increases, a part of the high-frequency components and noise components of small signals is lost in the LUT images Lα, Lβ, Lγ. Consequently, the processed image Pn has less enhanced fine high-frequency components and noise components. Moreover, in dynamic range compression processing, as the threshold “a” decreases, more high-frequency components of smaller signals are stored in the LUT images Lα, Lβ, Lγ. Consequently, the processed image Pn has suppressed fine high-frequency components and overshoot in comparison with the source image P0. In contrast to this, as the threshold “a” increases, the high-frequency components of small signals are more suppressed in the LUT images Lα, Lβ, Lγ. Consequently, more fine high-frequency components are stored and only extreme overshoot is suppressed in the processed image Pn.

### Image Processing Step S7

The image processing section 15 performs image processing, such as high-frequency enhancement processing and dynamic range compression processing, with the LUT images L generated by the image conversion section 13. Specific configuration thereof will be described hereinafter.

### High-Frequency Enhancement Processing

Description will be given of high-frequency enhancement processing. In performing the high-frequency enhancement processing, firstly, the image processing section 15 adds up the acquired LUT images L for generating a suppression sum image ΣLUT. The third LUT image Lγ differs from the first LUT image Lα and the second LUT image Lβ in size of the image, and thus they cannot be added up as they are (see FIG. 14.) Consequently, the image processing section 15 once magnifies the third LUT image Lγ, and adds the magnified image to the first LUT image Lα and the second LUT image Lβ. The suppression sum image ΣLUT contains no low-frequency component in the source image P0. That is because the frequency components lower than that extracted from the third band image γ are not summed to the suppression sum image ΣLUT.

The image processing section 15 performs a density conversion process to the suppression sum image ΣLUT, and generates a density conversion image USM (see FIG. 14.) The density conversion image USM contains the high-frequency components in the source image P0. Finally, the image processing section 15 adds the source image P0 and the density conversion image USM to generate a high-frequency enhanced image (a type of the processed image Pn.)

### Dynamic Range Compression Processing

Next, description will be given of dynamic range compression processing for controlling distributions of the pixel data in the source image P0. This processing may control a contrast in the source image P0. Where dynamic range compression processing is performed to the source image P0, the image processing section 15 firstly adds the band images α, β, γ, while magnifying them as appropriate, thereby generating a compression sum image ΣBP. The compression sum image ΣBP is obtained through removing the lower frequency components from the source image P0, and is formed of the pixel data.

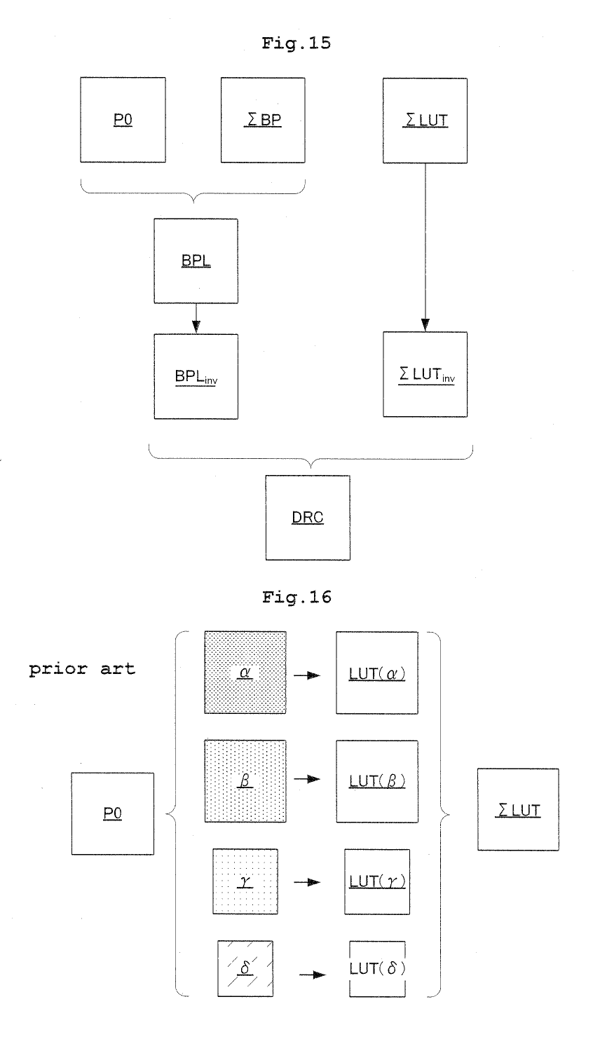

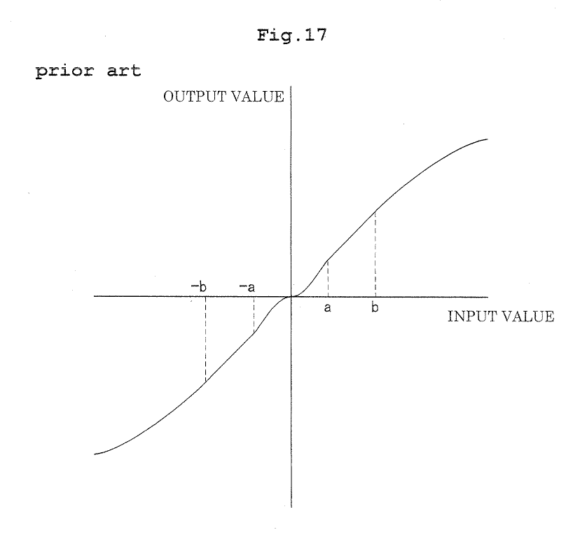

As illustrated in FIG. 15, the image processing section 15 subtracts the compression sum image ΣBP from the source image P0 to acquire a low-frequency component image BPL formed of only low-frequency components. Subsequently, the image processing section 15 reads a reversal table from the memory unit 28 for reversing the pixel data in the low-frequency component image BPL, thereby generating a reversed low-frequency component image BPLᵢₙᵥ. Here, the reversal table does not merely reverse the low-frequency component image BPL linearly. Specifically, a little reversal is given to a density region to be observed, whereas greater reversal is given to the other regions as they are away from the observation region. Consequently, a dynamic range in the entire image is compressed while the contrast of the density region to be observed is maintained.

Here, dynamic range compression processing is performed through addition of the reversed low-frequency component image BPLᵢₙᵥ and the source image P0. Here, the reversed low-frequency component image BPLᵢₙᵥ has no high-frequency component in the source image P0, but has reversed low-frequency components in the source image P0. Where the reversed low-frequency component image BPLᵢₙᵥ and the source image P0 are added under this state, the processed image Pn to be generated has partially and relatively excessive frequency components, which causes overshoot in the processed image Pn.

The image processing section 15 receives the controlled sum image ΣLUT from the image conversion section 13 for the purpose of suppressing the overshoot. Here, the translation table used upon generation of the LUT images L is for the dynamic range compression processing. The translation table is not always the same as that used for high-frequency enhancement processing. The graph indicating a relationship between the input and output values has a nonlinear profile symmetric about an origin point. Moreover, as mentioned later, the translation table Ta may be used for generation of the LUT image L. See FIG. 13 as for the graph indicating the relationship between the input and output values of the translation table Ta.

The LUT images Lα, Lβ, Lγ generated with the translation table Ta each have an extracted pixel value of a large absolute value in the band images α, Lα, β, γ. That is because the generated LUT images Lα, Lβ, Lγ are each a resultant image that a filter is applied to the band images Lα, Lβ, Lγ so as to pass the extreme pixel value only.

Accordingly, the sum LUT image ΣL generated from the LUT images Lα, Lβ, Lγ has weighted high-frequency components in the source image P0 in accordance with the tendency of the high-frequency components to be relatively excessive. Here, it is considered that the sum LUT image ΣL is generated based on the LUT images L having an extracted pixel value of an extremely large absolute value that the band images α, β, γ have. The pixel having the extremely large absolute value of the pixel values in the band image α, β, γhas no pixel value of “0” in the sum LUT image ΣL. The portion in the sum LUT image ΣL having no value of “0” corresponds to the portion in the processed image Pn having excessive high-frequency components.

The image processing section 15 reverses the pixel data in the suppression sum image ΣLUT, thereby generating a reversed suppression sum image ΣLUTᵢₙᵥ (see FIG. 15.) Here, inclination in the reversal table upon generating the reversed low-frequency component image BPLᵢₙᵥ is used. In so doing, the reversed suppression sum image ΣLUTᵢₙᵥ is formed of only pixel values in the suppression sum image ΣLUT that corresponds to a portion indicating a strong tendency to convert the pixel values of the reversed low-frequency component image BPLᵢₙᵥ upon generating the reversed low-frequency component image BPLᵢₙᵥ. The low-frequency components in the source image P0 are not contained in the suppression sum image ΣLUT.

Thereafter, the image processing section 15 adds the reversed suppression sum image ΣLUTᵢₙᵥ to the reversed low-frequency component image BPLᵢₙᵥ. Here, addition is made such that larger weighting is performed to the reversed low-frequency component image BPLᵢₙᵥ than that to the reversed suppression sum image ΣLUTᵢₙᵥ. Consequently, a reverse image DRC is generated (see FIG. 15.) The image processing section 15 adds the source image P0 and the reverse image DRC to generate a dynamic range compression processing image.

The reason will be described for individual obtaining of the reversed low-frequency component image BPLᵢₙᵥ and the reversed suppression sum image ΣLUTᵢₙᵥ upon generation of the dynamic range compression processing. The reversed low-frequency component image BPLᵢₙᵥ contains more low-frequency components of the source image P0, whereas the reversed suppression sum image ΣLUTᵢₙᵥ contains more high-frequency components of the source image P0. Variation of the table used for generating both sum images may control a balance of the dynamic range compression processing in the high-frequency components and that in the low-frequency components.

Description will be given of the reversal table for generating the reversed low-frequency component image BPLᵢₙᵥ. The reversal table is a table having a relationship between the input values expressing the pixel data that forms the low-frequency component image BPL and the output values expressing the pixel data that forms the reversed low-frequency component image BPLᵢₙᵥ. A portion of the table with the input value close to a reference value has an output value close to “0”. When seen are the input values increasing in order from the reference value in the reversal table, the output values take a negative value, and an absolute value thereof increases sharply as the input value increases. On the other hand, when seen are the input values reduced in order from the reference value in the reversal table, the output values take a positive value, and an absolute value thereof increases sharply as the input value increases.

For simple explanation, it is assumed that the dynamic range compression processing image is generated through addition of the source image P0 and the reversed low-frequency component image BPLᵢₙᵥ, and that the reversed suppression sum image ΣLUTᵢₙᵥ is not under consideration. Here, supposing that every pixel data forming the reversed low-frequency component image BPLᵢₙᵥ is “0”, the source image P0 and the dynamic range compression processing image are identical with each other. Moreover, supposing that the reversed low-frequency component image BPLᵢₙᵥ has a positive value on the right half thereof and a negative value on the left half thereof, the source image P0 has a bright portion on the right half and a dark portion on the left half.

The result of addition of the source image P0 and an actual reversed low-frequency component image BPLᵢₙᵥ is as under based on the above. That is, the pixel data of the reversed low-frequency component image BPLᵢₙᵥ has a value close to “0” in the portion of the source image P0 having the pixel data close to the reference value. Consequently, no subtraction is performed. A portion of the source image P0 having a larger value than the reference value (bright portion) becomes dark, since the pixel data of the reversed low-frequency component image BPLᵢₙᵥ has a negative value. On the other hand, a portion of the source image P0 having a smaller value than the reference value (dark portion) becomes bright, since the pixel data of the reversed low-frequency component image BPLᵢₙᵥ has a positive value. In this way, the dynamic range in the source image P0 is controlled for generating a dynamic range compression processing image (one type of processed images.)

### Operation of X-Ray Apparatus

Next, description will be given of operations of the X-ray apparatus 1. Firstly, the subject M is placed on the top board 2, and an operator instructs start of emitting radiation via the console 26. Then, the X-ray tube 3 emits X-rays, and the FPD 4 detects X-rays transmitting through the subject M. Here, the source image P0 is generated. The LUT images L are generated based on the source image P0.

The operator instructs execution of image processing selected from either high-frequency enhancement processing or dynamic range compression processing via the console 26. The image processing section 15 performs high-frequency enhancement processing or dynamic range compression processing in accordance with the operator's instructions. A projected image of the subject M having image processing performed thereto is displayed on a display screen 25, and operations of the X-ray apparatus 1 are completed.

According to Embodiment 1 as above, the LUT images L are generated in accordance with the translation table Ta. The translation table Ta has an output value of “0” where the absolute value of the input value is less than or equal to a threshold “a”. Where the absolute value of the input value is larger than the threshold “a”, the relationship between the input and output values may be indicated as a conventional smooth curve. According to the conventional configuration, it has been considered as under. That is, the relationship between the input and output values is indicated as a smooth curve relative to every input value. Otherwise, artifacts may appear in the image to be generated from the LUT images L. In contrast to this, no visible artifact appears where a discontinuous portion in the graph indicating the relationship between the input and output values has a threshold (and the opposite of the threshold) sufficiently close to “0”. Such configuration may realize easy formation of the translation table Ta even when the relationship is not determined with a complicated function as in the conventional art.

According to Embodiment 1, the threshold “a” may vary. As the threshold “a” increases, pixel data having a value of “0” increases that forms the LUT images L. Consequently, the state of image processing to the source image P0 is changed. In so doing, the operator may control the extent of image processing to the source image P0 by merely control of the threshold “a” of a single value.

This invention is not limited to the foregoing configurations, but may be modified as follows. High-frequency enhancement processing will be described by way of example.

(1) In addition to the foregoing Embodiment 1, the threshold “a” may vary depending on a site to be imaged or on types of operations. That is, the source image P0 contains data on a site to be imaged or types of operations. The threshold changing section 14 reads out the data on the site to be images or types of operations for determination of the threshold “a”. Specifically, the threshold changing section 14 uses a correlated table having a relationship between the threshold that the memory unit 28 memorizes and the site to be imaged or types of operations, thereby determining the threshold “a”.

The state where the image of the subject M falls on the source image P0 differs in accordance with the site to be imaged or types of operations. Accordingly, variation of the threshold “a” in accordance with the site to be imaged or types of operations may realize proper image processing to the image of the subject M falling on the source image P0. Next, description will be given in detail of variations in the threshold “a”. Firstly, the operator selects a site to be imaged, such as a bone trabecula, or types of operations for micro structural observation via the console 26 to perform imaging. In this case, the threshold changing section 14 changes the threshold “a” to be a smaller one. Accordingly, the image processing is performed with the high-frequency components in the source image P0 being positively enhanced. Consequently, this image processing is suitable for micro structural observation of the subject.

Moreover, the operator selects a site to be imaged or types of operations for soft tissue observation via the console 26 to perform imaging. In this case, the threshold changing section 14 changes the threshold “a” to be a larger one. Accordingly, the noise components in the source image P0 are not enhanced, but only a rough structure is enhanced to perform imaging. Consequently, this image processing is suitable for rough structural observation of the subject.

(2) In addition to the foregoing configuration, the threshold “a” may vary in each band image α, β, γ. The threshold “a” varies in each band image α, β, γ, whereby image processing may be controlled with higher flexibility. In addition, the operator only controls limited types of parameters for operations. Consequently excellent ease of operation may be achieved. Next, description will be given in detail of variations in the threshold “a”. For performing image processing with enhanced microstructure in the source image P0, the operator inputs instruction to the threshold changing section 14 via the console 26 as to set the threshold “a” smaller as the frequency components in the band images α, β, γbecome higher. Accordingly, the image processing is performed with the high-frequency components in the source image P0 being positively enhanced. Consequently, this image processing is suitable for micro structural observation of the subject.

For performing image processing with enhanced soft tissue in the source image P0, the operator inputs instruction to the threshold changing section 14 via the console 26 as to set the threshold “a” larger as the frequency components in the band images α, β, γ become higher. Accordingly, the mage processing is performed with the noise components in the source image P0 not being enhanced, but only a rough structure being enhanced. Consequently, this image processing is suitable for observation of the rough structure of the subject.

(3) In addition to the foregoing configurations, the threshold “a” may vary depending on an amount of exposure (a dose of X-rays) in taking the source image P0. That is, the main controller 27 sends data on the dose of X-rays to the threshold changing section 14. The threshold changing section 14 determines the threshold “a” from the data on the dose of X-rays. Specifically, the threshold changing section 14 uses a correlated table having a relationship between the threshold that the memory unit 28 memorizes and the dose of X-rays, thereby determining the threshold “a”.

The foregoing configuration is one example of specific configurations of this invention. The threshold “a” differs in accordance with an amount of exposure in taking the source image. In this way, image processing may be controlled with higher flexibility. Next, description will be given in detail of variations in the threshold “a”. For instance, the threshold changing section 14 sets the threshold “a” larger as the dose of X-rays in taking the source image P0 decreases. That is because the decreased dose of X-rays leads to increase of the noise components in the source image P0 , and thus more suppression is needed of enhancement of the noise components in the processed image Pn.

According to the foregoing explanation, the threshold “a” increases as the dose of X-rays decreases. On the other hand, in so doing, the influence on the step explained in FIG. 13 may appear in the processed image Pn. Consequently, where the dose of X-rays decreases to some extent, the threshold “a” may be set as not to increase although the dose of X-rays decreases over the extent.

Moreover, for observation of the bone portion, the threshold changing section 14 reduces the threshold “a” as the dose of X-rays in taking the source image P0 decreases. The reason for the above will be described. Since the bone portion has difficulty in transmitting X-rays, the image of the bone portion in the source image P0 is dark compared with the other portions. As the dose of X-rays decreases, the image of the bone portion becomes darker. The threshold “a” may decrease for enhancement of the fine image of the bone portion.

(4) In Embodiment 1, the threshold changing section 14 may change the threshold in accordance with types of image processing that the operator sets via the console 26 for realizing control of the image processing with higher flexibility. In this modification, selection instructions of the image processing via the console 26 are sent to the threshold changing section 14. The threshold changing section 14 changes the threshold depending on the selection instructions.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An image processing method with use of band images, comprising:
a band image generation step for generating the band images through extracting a portion of frequency components in a source image having a subject image falling thereon;
a conversion step for converting each of the band images into an absolute value suppression image having a suppressed absolute value of pixel data in reference to input values prior to conversion as well as output values subsequent to the conversion; and
an image processing step for performing image processing to the source image based on the absolute value suppression image,
in the conversion step, the translation table to be referred to having an output value of “0” where the absolute value of the input value is less than or equal to a threshold, the translation table to be referred to having an output value that increases in accordance with increase of an input value where the input value is positive and larger than the threshold, and the translation table to be referred to having an output value that decreases in accordance with decrease of an input value where the input value is negative and smaller than the opposite of the threshold.

2. The image processing method according to claim 1, wherein
the image processing method further comprises a threshold changing step for receiving an input instruction to vary the threshold having an upper limit of a given value.

3. The image processing method according to claim 1, wherein
the threshold used for conversion of the band images in the conversion step differs in accordance with a site to be imaged or types of operations.

4. The image processing method according to claim 1, wherein
the threshold used for conversion of the band images in the conversion step differs in each band image.

5. The image processing method according to claim 1, wherein
the threshold used for conversion of the band images in the conversion step differs in accordance with an amount of exposure in taking the source image.

6. The image processing method according to claim 1, wherein
high-frequency enhancement processing for enhancement of the high-frequency components to the source image or dynamic range compression processing for controlling distribution of the pixel data in the source image is performed in the image processing step.

7. The image processing method according to claim 6, wherein
the threshold used for conversion of the band images in the conversion step differs in accordance with types of image processing.

8. Radiographic apparatus for performing image processing with use of band images, comprising:
a radiation source for emitting radiation;
a radiation detecting device for detecting radiation;
a source image generation device for generating a source image, that has a subject image falling thereon, based on detection signals outputted from the radiation detecting device;
a band image generation device for generating the band images through extracting a portion of frequency components in the source image;
a conversion device for converting each of the band images into an absolute value suppression image having a suppression absolute value of pixel data in reference to input values prior to conversion as well as output values subsequent to the conversion; and
an image processing device for performing image processing to the source image based on the absolute value suppression image,
the translation table to be referred to having an output value of “0” where the absolute value of the input value is less than or equal to a threshold, the translation table to be referred to having an output value that increases in accordance with increase of an input value where the input value is positive and larger than the threshold, and the translation table to be referred to having an output value that decreases in accordance with decrease of an input value where the input value is negative and smaller than the opposite of the threshold.

9. The radiographic apparatus according to claim 8, further comprising:
a threshold changing device for receiving an input instruction to vary the threshold having an upper limit of a given value.

10. The radiographic apparatus according to claim 8, wherein
the threshold that the conversion device adopts for conversion of the band images differs in accordance with a site to be imaged or types of operations.

11. The radiographic apparatus according to claim 8, wherein
the threshold that the conversion device adopts for conversion of the band images differs in each band image.

12. The radiographic apparatus according to claim 8, wherein
the threshold that the conversion device adopts for conversion of the band images differs in accordance with an amount of exposure in taking the source image.

13. The radiographic apparatus according to claim 8 wherein
the image processing device performs high-frequency enhancement processing for enhancement of the high-frequency components to the source image or dynamic range compression processing for controlling distribution of the pixel data in the source image.

14. The radiographic apparatus according to claim 13, wherein
the threshold that the conversion device adopts for conversion of the band images differs in accordance with types of image processing.
